(19) United States
(12) Patent Application Publication
(10) Pub. No.: US 2025/0137647 A1
(43) Pub. Date: May 1, 2025

(54) COOKTOP APPLIANCE PRECISION MODE WITH IMPROVED PRECISION COOKING

(71) Applicant: Haier US Appliance Solutions, Inc., Wilmington, DE (US)

(72) Inventor: Omar Santana, Louisville, KY (US)

(21) Appl. No.: 18/497,563

(22) Filed: Oct. 30, 2023

(51) Int. Cl. F24C 3/12; F24C 7/08; G01K 3/00; H05B 1/02

(52) U.S. Cl. CPC F24C 3/126; F24C 7/083; G01K 3/005; H05B 1/0266; H05B 2213/07

(57) ABSTRACT

A method of operating a cooktop appliance in a precision cooking mode includes activating a heating element positioned at a cooking surface and monitoring the temperature at the utensil heated by the heating element during the precision cooking mode. The method also includes operating the heating element at a first predetermined power level when the monitored temperature at the utensil is within a first temperature band and determining, after operating the heating element at the first predetermined power level, the monitored temperature at the utensil is within a second temperature band. The method further includes adjusting the operation of the heating element based on the first temperature band and the second temperature band in response to determining the monitored temperature at the utensil is within the second temperature band.

### FIELD OF THE INVENTION

The present subject matter relates generally to cooktop appliances, including cooktop appliances configured for precise temperature control.

### BACKGROUND OF THE INVENTION

Cooktop appliances generally include heating elements for heating cooking utensils, such as pots, pans and griddles. A user can select a desired heating level, and operation of one or more of the heating elements is modified to match the desired heating level. For example, certain cooktop appliances include electric heating elements. During operation, the cooktop appliance operates the electric heating elements at a predetermined power output corresponding to a selected heating level. As another example, some cooktop appliances include gas burners as heating elements. During operation, the heat output of the gas burner is modulated by adjusting a position of a control valve coupled to the gas burner, e.g., a power level of such heating elements may be or correspond to a control valve position.

Some cooktop appliances are operable in a precision mode, which generally uses a closed loop control algorithm to vary the output of the heating element in response to a target temperature or setpoint temperature and a measured temperature, e.g., of or at the cooking utensil. Typical closed loop control algorithms (e.g., Proportional Integral Derivative control algorithms) may frequently overshoot the target temperature or may be slow to recover to the target temperature when the temperature drops due to disturbances such as adding food to a cooking utensil. Furthermore, it may be impossible to improve some aspects of the temperature response (e.g., temperature recovery speed) without negatively impacting other aspects (e.g., temperature overshoot). Thus, typical closed loop algorithms may not produce the optimal or desired results.

Accordingly, a cooktop appliance with features for improved precision temperature control would be useful.

### BRIEF DESCRIPTION OF THE INVENTION

Aspects and advantages of the invention will be set forth in part in the following description, or may be apparent from the description, or may be learned through practice of the invention.

In one example embodiment, a method of operating a cooktop appliance is provided. The cooktop appliance includes a user interface, a heating element positioned at a cooking surface of the cooktop appliance, and a controller in communication with a temperature sensor configured to measure a temperature at a utensil heated by the heating element. The method includes receiving a precision cooking mode initiation signal and initiating the precision cooking mode in response to the precision cooking mode initiation signal. The precision cooking mode includes activating the heating element positioned at the cooking surface. The method also includes monitoring the temperature at the utensil heated by the heating element during the precision cooking mode. The method further includes operating the heating element at a first predetermined power level when the monitored temperature at the utensil is within a first temperature band. The method also includes determining the monitored temperature at the utensil is within a second temperature band after operating the heating element at the first predetermined power level, and adjusting the operation of the heating element based on the first temperature band and the second temperature band in response to determining the monitored temperature at the utensil is within the second temperature band.

In another example embodiment, a method of operating a cooktop appliance is provided. The cooktop appliance includes a user interface, a heating element positioned at a cooking surface of the cooktop appliance, and a controller in communication with a temperature sensor configured to measure a temperature at a utensil heated by the heating element. The method includes receiving a precision cooking mode initiation signal and a setpoint temperature and initiating the precision cooking mode in response to the precision cooking mode initiation signal. The precision cooking mode comprises activating the heating element positioned at the cooking surface at a first power level. The first power level is based on the setpoint temperature. The method also includes monitoring the temperature at the utensil heated by the heating element during the precision cooking mode, inputting the monitored temperature into a closed loop control algorithm, and determining an output of the closed loop control algorithm. The output includes a request to operate the heating element at a second power level. The method further includes determining at least one of a time limit and a rate of power change threshold is satisfied after determining the output of the closed loop control algorithm and operating the heating element at the second power level based on the output of the closed loop control algorithm and on the at least one of the time limit and the rate of temperature change threshold.

In another example embodiment, a cooktop appliance is provided. The cooktop appliance includes a user interface. The cooktop appliance also includes a heating element positioned at a cooking surface of the cooktop appliance and a controller in communication with a temperature sensor configured to measure a temperature at a utensil heated by the heating element. The cooktop appliance further includes a controller. The controller is configured for receiving a precision cooking mode initiation signal and initiating the precision cooking mode in response to the precision cooking mode initiation signal. The precision cooking mode includes activating the heating element positioned at the cooking surface. The controller is also configured for monitoring the temperature at the utensil heated by the heating element during the precision cooking mode. The controller is further configured for operating the heating element at a first predetermined power level when the monitored temperature at the utensil is within a first temperature band. The controller is also configured for determining the monitored temperature at the utensil is within a second temperature band after operating the heating element at the first predetermined power level, and adjusting the operation of the heating element based on the first temperature band and the second temperature band in response to determining the monitored temperature at the utensil is within the second temperature band.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front, perspective view of a range appliance having a cooktop according to one or more example embodiments of the present subject matter.

FIG. 2 provides a top, plan view of the example appliance of FIG. 1.

FIG. 3 is a schematic top view of an exemplary cooktop according to one or more example embodiments of the present subject matter which may be incorporated into a range appliance such as the range appliance of FIG. 1.

FIG. 4 provides a schematic diagram of a control system as may be used with the exemplary cooktop appliance of FIG. 3.

FIG. 5 provides a schematic diagram of an additional exemplary embodiment of a temperature sensor which may be incorporated into a cooktop appliance in accordance with one or more embodiments of the present subject matter.

FIG. 6 graphically illustrates an exemplary plurality of temperature bands, a series of temperature changes across the temperature bands, and power level changes at some band crossings in an exemplary precision cooking operation according to one or more embodiments of the present disclosure.

FIG. 7 provides an exemplary lookup table for temperature band power levels based on temperature setpoints which may be used in one or more exemplary precision cooking operations according to various embodiments of the present disclosure.

FIG. 8 provides a flow chart illustrating an exemplary method of operating a cooktop appliance according to one or more example embodiments of the present subject matter.

FIG. 9 provides another flow chart illustrating an additional exemplary method of operating a cooktop appliance according to one or more example embodiments of the present subject matter.

FIG. 10 provides another flow chart illustrating an additional exemplary method of operating a cooktop appliance according to one or more example embodiments of the present subject matter.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Furthermore, the skilled artisan will recognize the interchangeability of various features from different embodiments. Similarly, the various method steps and features described, as well as other known equivalents for each such methods and features, can be mixed and matched by one of ordinary skill in this art to construct additional systems and techniques in accordance with principles of this disclosure. Of course, it is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

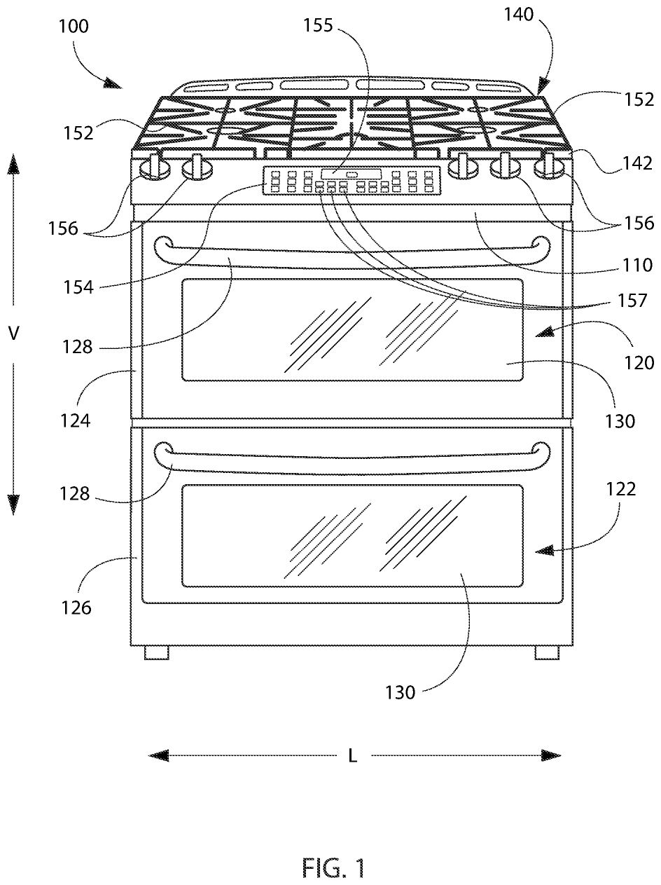

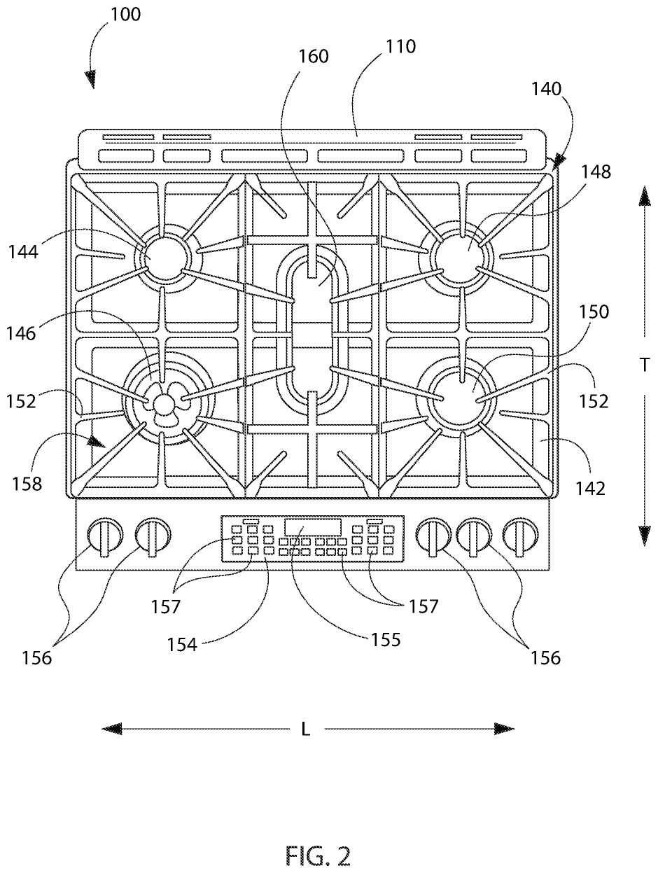

FIG. 1 provides a front, perspective view of a cooktop appliance 100 as may be employed with the present subject matter. FIG. 2 provides a top, plan view of cooktop appliance 100. As illustrated in FIGS. 1 and 2, the example cooktop appliance 100 includes an insulated cabinet 110. Cabinet 110 defines an upper cooking chamber 120 and a lower cooking chamber 122. Thus, this particular exemplary cooktop appliance 100 is generally referred to as a double oven range appliance. As will be understood by those skilled in the art, range appliance 100 is provided by way of example only, and the present subject matter may be used in any suitable cooktop appliance, e.g., a single oven range appliance or a standalone cooktop appliance. In other exemplary embodiments of the present disclosure, the cooktop appliance may include a single cooking chamber, or no cooking chamber at all, such as a standalone cooktop appliance, e.g., which may be built in to a countertop. Thus, the example embodiment shown in FIG. 1 is not intended to limit the present subject matter to any particular cooking chamber configuration or arrangement (or even the presence of a cooking chamber at all, e.g., as in the case of a standalone cooktop appliance).

Upper and lower cooking chambers 120 and 122 are configured for the receipt of one or more food items to be cooked. Cooktop appliance 100 includes an upper door 124 and a lower door 126 rotatably attached to cabinet 110 in order to permit selective access to upper cooking chamber 120 and lower cooking chamber 122, respectively. Handles 128 are mounted to upper and lower doors 124 and 126 to assist a user with opening and closing doors 124 and 126 in order to access cooking chambers 120 and 122. As an example, a user can pull on handle 128 mounted to upper door 124 to open or close upper door 124 and access upper cooking chamber 120. Glass window panes 130 provide for viewing the contents of upper and lower cooking chambers 120 and 122 when doors 124 and 126 are closed and also assist with insulating upper and lower cooking chambers 120 and 122. Heating elements (not shown), such as electric resistance heating elements, gas burners, microwave heating elements, halogen heating elements, or suitable combinations thereof, are positioned within upper cooking chamber 120 and lower cooking chamber 122 for heating upper cooking chamber 120 and lower cooking chamber 122.

Cooktop appliance 100 also includes a cooktop 140. Cooktop 140 is positioned at or adjacent to a top portion of cabinet 110. Thus, cooktop 140 is positioned above upper and lower cooking chambers 120 and 122. Cooktop 140 includes a top panel 142. By way of example, top panel 142 may be constructed of glass, ceramics, stainless steel, enameled steel, and combinations thereof.

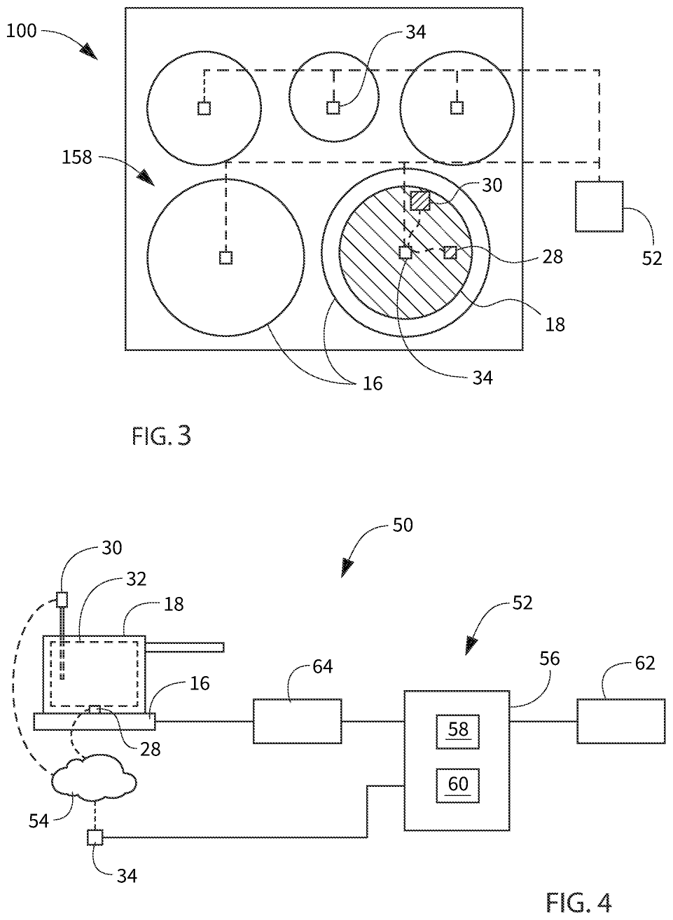

For cooktop appliance 100, a utensil 18 (see, e.g., FIGS. 3, 4, and 5) holding food and/or cooking liquids (e.g., oil, water, etc.) may be placed onto grates 152 at a location of any of burner assemblies 144, 146, 148, 150. Burner assemblies 144, 146, 148, 150 provide thermal energy to cooking utensils on grates 152. As shown in FIG. 2, burner assemblies 144, 146, 148, 150 can be configured in various sizes so as to provide e.g., for the receipt of cooking utensils (i.e., pots, pans, etc.) of various sizes and configurations and to provide different heat inputs for such cooking utensils. Grates 152 are supported on a cooking surface, e.g., top surface 158 of top panel 142. Range appliance 100 also includes a griddle burner 160 positioned at a middle portion of top panel 142, as may be seen in FIG. 2. A griddle may be positioned on grates 152 and heated with griddle burner 160.

A user interface panel 154 is located within convenient reach of a user of the range appliance 100. For this example embodiment, range appliance 100 also includes knobs 156 that are each associated with one of burner assemblies 144, 146, 148, 150 and griddle burner 160. Knobs 156 allow the user to activate each burner assembly and determine the amount of heat input provided by each burner assembly 144, 146, 148, 150 and griddle burner 160 to a cooking utensil located thereon. The user interface panel 154 may also include one or more inputs 157, such as buttons or a touch pad, for selecting or adjusting operation of the range appliance 100, such as for selecting or initiating a precision cooking mode, as will be described in more detail below. User interface panel 154 may also be provided with one or more graphical display devices 155 that deliver certain information to the user such as e.g., whether a particular burner assembly is activated and/or the temperature at which the burner assembly is set.

Although shown with knobs 156, it should be understood that knobs 156 and the configuration of range appliance 100 shown in FIG. 1 is provided by way of example only. More specifically, range appliance 100 may include various input components, such as one or more of a variety of touch-type controls, electrical, mechanical or electro-mechanical input devices including rotary dials, push buttons, and touch pads. The user interface panel 154 may include other display components, such as a digital or analog display device 155, designed to provide operational feedback to a user.

As will be discussed in greater detail below, the cooktop appliance 100 includes a control system 50 (FIG. 4) for controlling one or more of a plurality of heating elements 16. Specifically, the control system 50 may include a controller 52 (FIGS. 3, 4, and 5) operably connected to the user interface panel 154 and controls, e.g., knobs 156. The controller 52 may be operably connected to each of the plurality of heating elements 16 for controlling a power supply and/or flow of gaseous fuel to each of the plurality of heating elements 16 in response to one or more user inputs received through the interface panel 154 and controls.

FIG. 3 is a schematic view of certain components of cooktop appliance 100. In particular, as shown in FIG. 3, cooktop appliance 100 includes a plurality of heating elements 16, which may be gas burners, e.g., as in the exemplary embodiments illustrated in FIGS. 1 and 2 and described above, or may be electric heating elements, such as induction heating elements or resistance heating elements.

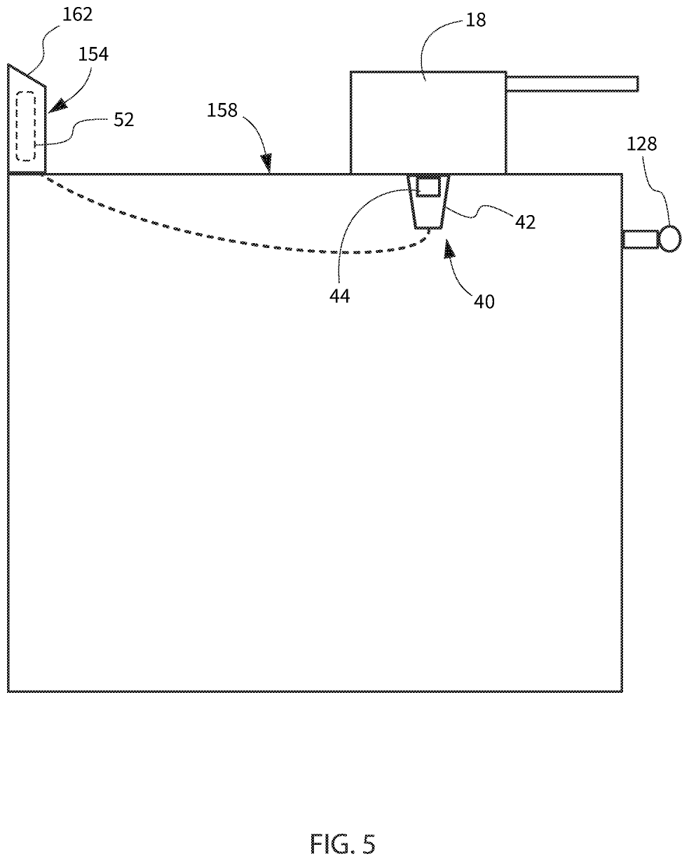

Referring now to FIG. 3, a top, schematic view of a cooktop, which may be, e.g., the cooktop 140 of FIG. 1, is provided. As stated, the cooking surface 158 of the cooktop 140 for the embodiment depicted includes five heating elements 16 spaced along the cooking surface 158. The heating elements 16 may be gas burners, e.g., as illustrated in FIGS. 1 and 2, or may be electric heating elements such as resistance heating elements or induction heating elements, etc. A cooking utensil 18, also depicted schematically, is positioned on a first heating element 16 of the plurality of heating elements 16. As noted above, the cooking utensil 18 may be positioned above the cooking surface 158, e.g., on a grate 152, in embodiments where the heating element 16 is a gas burner. In other embodiments, e.g., where the heating element 16 is a radiant electric heating element or an induction heating element, the cooking utensil 18 may be positioned directly on the cooking surface 158. Further, in embodiments where the heating element 16 is a coil electrical resistance heating element, the cooking utensil 18 may be positioned on the heating element 16. For the embodiment depicted in FIGS. 3 and 4, a cookware temperature sensor 28 and a food temperature sensor 30 are also associated with the cooking utensil 18. In additional embodiments, a temperature sensor may also be integrated into the cooktop, such as a pop-up sensor 40, as illustrated in FIG. 5 and described in further detail below.

In some example embodiments, the cookware temperature sensor 28 may be in contact with, attached to, or integrated into the cooking utensil 18 and configured to sense a temperature of, e.g., a bottom surface of the cooking utensil 18 or bottom wall of the cooking utensil 18. For example, the cookware temperature sensor 28 may be embedded within the bottom wall of the cooking utensil 18 as illustrated in FIG. 3. Alternatively, however, the cookware temperature sensor 28 may be attached to or integrated within the cooking surface 158 of the cooktop appliance 100. For example, the cookware temperature sensor 28 may be integrated into one or more of the heating elements 16, such as pop-up sensor 40 of FIG. 5. With such an exemplary embodiment, the cookware temperature sensor 28 may be configured to physically contact the bottom surface of a bottom wall of the cooking utensil 18 when the cooking utensil 18 is placed on the heating element 16 into which the temperature sensor 28 is integrated. Alternatively, cookware temperature sensor 28 may be positioned proximate to the bottom surface or bottom wall of the cooking utensil 18 when the cooking utensil 18 is placed on the heating element 16.

Additionally, the food temperature sensor 30 may be positioned at any suitable location to sense a temperature of one or more food items 32 (see FIG. 4) positioned within the cooking utensil 18. For example, the food temperature sensor 30 may be a probe type temperature sensor configured to be inserted into one or more food items 32. Alternatively, however, the food temperature sensor 30 may be configured to determine a temperature of one or more food items positioned within the cooking utensil 18 in any other suitable manner.

In certain exemplary embodiments, one or both of the cookware temperature sensor 28 and the food temperature sensor 30 may utilize any suitable technology for sensing/determining a temperature of the cooking utensil 18 and/or food items 32 positioned in the cooking utensil 18. The cookware temperature sensor 28 and the food temperature sensor 30 may measure a respective temperature by contact and/or non-contact methods. For example, one or both of the cookware temperature sensor 28 and the food temperature sensor 30 may utilize one or more thermocouples, thermistors, optical temperature sensors, infrared temperature sensors, resistance temperature detectors (RTD), etc.

Referring again to FIGS. 3 and 4, the cooktop appliance 100 additionally includes at least one receiver 34. In the illustrated example of FIG. 3, the cooktop appliance 100 includes a plurality of receivers 34, each receiver 34 associated with an individual heating element 16. Each receiver 34 is configured to receive a signal from the food temperature sensor 30 indicative of a temperature of the one or more food items 32 positioned within the cooking utensil 18 and/or from the cookware temperature sensor 28 indicative of a temperature of the cooking utensil 18 positioned on a respective heating element 16. In other embodiments, a single receiver 34 may be provided and the single receiver 34 may be operatively connected to one or more of the sensors. In at least some exemplary embodiments, one or both of the cookware temperature sensor 28 and the food temperature sensor 30 may include wireless transmitting capabilities, or alternatively may be hard-wired to the receiver 34, e.g., through a wired communications bus.

FIG. 4 provides a schematic view of a system for operating a cooktop appliance 100 in accordance with an exemplary embodiment of the present disclosure. Specifically, FIG. 4 provides a schematic view of a heating element 16 of the exemplary cooktop appliance 100 of FIGS. 1 and 2 and an exemplary control system 50.

As stated, the cooktop appliance 100 includes a receiver 34 associated with one or more of the heating elements 16, for example a plurality of receivers 34 each associated with a respective heating element 16. For the embodiment depicted, each receiver 34 is positioned directly below a center portion of a respective heating element 16. Moreover, for the embodiment depicted, each receiver 34 is configured as a wireless receiver 34 configured to receive one or more wireless signals. Specifically, for the exemplary control system 50 depicted, both of the cookware temperature sensor 28 and the food temperature sensor 30 are configured as wireless sensors in wireless communication with the wireless receiver 34 via a wireless communications network 54. In certain exemplary embodiments, the wireless communications network 54 may be a wireless sensor network (such as a BLUETOOTH communication network), a wireless local area network (WLAN), a point-to point communication networks (such as radio frequency identification (RFID) networks, near field communications networks, etc.), a combination of two or more of the above communications networks, or any suitable wireless communications network or networks.

Referring still to FIG. 4, each receiver 34 associated with a respective heating element 16 is operably connected to a controller 52 of the control system 50. The receivers 34 may be operably connected to the controller 52 via a wired communication bus (as shown), or alternatively through a wireless communication network similar to the exemplary wireless communication network 54 discussed above. The controller 52 may generally include a computing device 56 having one or more processor(s) 58 and associated memory device(s) 60. The computing device 56 may be configured to perform a variety of computer-implemented functions to control the exemplary cooktop appliance 100. The computing device 56 can include a general purpose computer or a special purpose computer, or any other suitable computing device. It should be appreciated, that as used herein, the processor 58 may refer to a controller, a microcontroller, a microcomputer, a programmable logic controller (PLC), an application specific integrated circuit, and other programmable circuits. Additionally, the memory device(s) 60 may generally comprise memory element(s) including, but not limited to, computer readable medium (e.g., random access memory (RAM)), computer readable non-volatile medium (e.g., a flash memory), a compact disc-read only memory (CD-ROM), a magneto-optical disk (MOD), a digital versatile disc (DVD), and/or other suitable memory elements. The memory 60 can store information accessible by processor(s) 58, including instructions that can be executed by processor(s) 58. For example, the instructions can be software or any set of instructions that when executed by the processor(s) 58, cause the processor(s) 58 to perform operations. For the embodiment depicted, the instructions may include a software package configured to operate the system to, e.g., execute the exemplary methods described below.

Referring again to FIG. 4, the control system 50 additionally includes a user interface 62 operably connected to the controller 52. For the embodiment depicted, e.g., in FIG. 4, the user interface 62 is configured in wired communication with the controller 52. However, in other exemplary embodiments, the user interface 62 may additionally or alternatively be wirelessly connected to the controller 52 via one or more suitable wireless communication networks (such as the exemplary wireless communication network 54 described above). In certain exemplary embodiments, user interface 62 may be configured as the user interface panel 154 and plurality of controls, e.g., knobs 156, on the cooktop appliance 100 (see, e.g., FIG. 1). Additionally, or alternatively, the user interface 62 may be configured as an external computing device or remote user interface device, such as a smart phone, tablet, or other device capable of connecting to the controller 52 of the exemplary control system 50. For example, in some embodiments, the remote user interface may be an application or “app” executed by a remote user interface device such as a smart phone or tablet. Signals generated in controller 52 operate the cooktop appliance 100 in response to user input via the user interface 62.

Further, the controller 52 is operably connected to each of the plurality of heating elements 16 for controlling an operating level, such as a supply of power or a flow of fuel, to each of the plurality of heating elements 16 in response to one or more user inputs through the user interface 62 (e.g., user interface panel 154 and/or controls, e.g., knobs 156). For example, the controller 52 may be operably connected to each of the plurality of heating elements 16 via a plurality of control devices 64, e.g., the controller 52 may be operably connected to the plurality of control devices 64, and each control device 64 may be associated with a respective one of the heating elements 16. In embodiments wherein one or more of the heating elements 16 are configured as electric resistance heaters, the controller 52 may be operably connected to respective relays, triodes for alternating current, or other devices for controlling an amount of power supplied to such electrical resistance heaters, each of which is an exemplary embodiment of control devices 64. Alternatively, in embodiments where one or more of the heating elements 16 are configured as induction heating elements, the controller 52 may be operably connected to respective current control devices, e.g., the control devices 64 operably connected to controller 52 may be respective current control devices for each induction heating element. As another example, in embodiments wherein one or more of the heating elements 16 are configured as gas burners, the control devices 64 may include one or more gas supply valves fluidly coupled to each gas burner for selectively adjusting or restricting, e.g., cutting off, a flow of fuel to each gas burner from a fuel supply.

In some embodiments, e.g., as illustrated in FIG. 5, the cooktop appliance 100 may include a backsplash 162. In such embodiments, the user interface panel 154 may be provided on the backsplash 162.

As mentioned above, in some embodiments a cookware temperature sensor may be attached to or integrated within the cooking surface 158 of the cooktop appliance 100, such as integrated into one or more of the heating elements 16. One example of such embodiments is illustrated in FIG. 5, where a pop-up temperature sensor 40 is integrated into an exemplary one heating element 16 (the heating element itself is not specifically illustrated in FIG. 5 to more clearly depict the pop-up sensor 40) below the cooking surface 158. In particular, the pop-up sensor 40 includes a main body or housing 42 which is fixed in place below the cooking surface 158 and a movable contact temperature probe 44 which is movable, e.g., generally along the vertical direction V, between an extended position (not shown) and a retracted position, as illustrated in FIG. 5, when the probe 44 is in contact with a cooking utensil 18 placed on the cooking surface 158. For example, the pop-up sensor 40 may include a biasing element such as a spring positioned within the housing 42 and positioned between the housing 42 and the probe 44 to bias the probe 44 upwards, e.g., whereby the probe 44 pops up above the cooking surface 158 when a cooking utensil is not present and whereby the weight of a cooking utensil presses the probe downwards, e.g., to or towards the retracted position, when the cooking utensil is present. Thus, for example, the probe 44 of the pop-up temperature sensor 40 may be biased against the bottom outer surface of the cooking utensil 18 when the cooking utensil 18 is placed on or above the heating element 16, such as to promote contact between the probe 44 and the cooking utensil 18 for measurement of the temperature of the cooking utensil 18 by the probe 44.

As mentioned above, the temperature sensor or sensors may be communicatively coupled with the controller 52 by a wired or wireless connection.

For example, in the illustrated embodiment of FIG. 5, the pop-up sensor 40 is coupled to the controller 52 by a wired connection. In such embodiments, the receiver 34 described above may be omitted. In additional embodiments, the pop-up sensor 40 of FIG. 5 may be in wireless communication with the controller 52, e.g., in a similar manner as described above with reference to FIGS. 3 and 4.

According to various embodiments of the present disclosure, the cooktop appliance 100 may be configured for a precision cooking mode and/or methods of operating the cooktop appliance 100 may include a precision cooking mode. Precision cooking modes generally include a closed loop control algorithm used to automatically (e.g., without user input such as adjusting the knobs 156) adjust the heating levels of one or more of the heating elements 16. Closed loop control algorithms are generally understood by those of ordinary skill in the art, e.g., wherein temperature measurements are compared to target temperature or setpoint temperature (e.g., user-defined setpoint temperature) to adjust the power level of one or more respective heating elements. Utilizing temperature measurements from one or more of the temperature sensors 28, 30, and/or 40, controller 52 may adjust the control device(s) 64 associated with the heating element 16 currently in use. For example, the user may turn on the closed loop control system by initiating precision cooking mode, such as by pressing or otherwise manipulating a corresponding one of the inputs or controls of the user interface 62. In some embodiments, such inputs and/or controls of the user interface 62 may also be used to input a user-defined set temperature or target temperature for the cooking operation. Additionally or alternatively, such inputs and/or controls of the user interface 62 may also be used to select a food attribute (e.g., type, quantity, volume, etc.), cooking method, or the like, which may be used by the cooking appliance to determine the target temperature for the cooking operation.

When the closed loop control system is activated, controller 52 receives the temperature measurements from temperature sensor 28, 30, and/or 40 and compares the temperature measurements to a target temperature, e.g., the user-defined set temperature or a predetermined target temperature based on a current stage of the precision cooking mode and/or based on a selected food attribute, e.g., type, quantity, volume, etc. In order to reduce a difference between the temperature measurements from the temperature sensor(s) and the target temperature, controller 52 adjusts the respective control device 64. Thus, the heat output provided by the heating element 16 may be regulated by the closed loop control system, e.g., without additional user input and/or monitoring.

A user may establish the set temperature via the user interface 62, e.g., the user interface may include knobs 156, inputs 157, and a display 155, as in the illustrated example embodiment of FIG. 2. Controller 52 is in communication with user interface 62 and is configured to receive the user-determined set temperature from user interface 62. User interface 62 may correspond to user interface panel 154 and/or controls, e.g., knobs 156, in certain example embodiments. Thus, the user may, for example, utilize keys 157 on user interface panel 154 and/or a rotary position of one of the knobs 156 to establish the set temperature and/or input other desired cooking parameters.

In some example embodiments, user interface 62 is positioned on top panel 142 and may be in communication with controller 52 via a wiring harness. As another example, user interface 62 may also or instead correspond to an application on a smartphone or other device, and the user may utilize the application, e.g., to establish the set temperature. In such example embodiments, user interface 62 may be in wireless communication with controller 52, e.g., via a BLUETOOTH® or WI-FI® connection.

Now that the construction of cooktop appliance 100 and the configuration of controller 52 according to exemplary embodiments have been presented, exemplary methods of operating a cooktop appliance will be described. Although the discussion below refers to the exemplary cooktop appliance 100, one skilled in the art will appreciate that the exemplary methods described herein are applicable to the operation of a variety of other cooktop appliances, such as a countertop cooktop appliance and other example cooktop appliances mentioned above as well as other suitable cooktop appliances as will be recognized by those of ordinary skill in the art. In exemplary embodiments, the various method steps as disclosed herein may be performed, e.g., in whole or part, by controller 52 or another, separate, dedicated controller, and/or by one or more remote computing devices, such as in a distributed computing environment, e.g., in the cloud, the fog, or the edge.

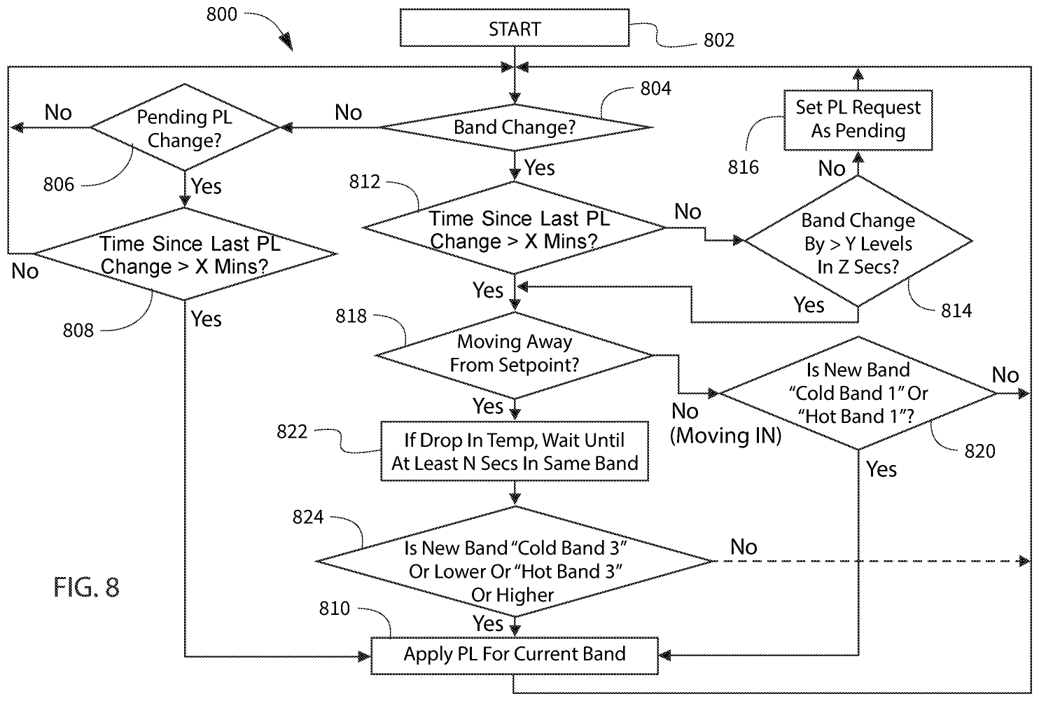

The accompanying FIGS., e.g., FIGS. 8, 9, and 10, depict steps performed in a particular order for purpose of illustration and discussion. Those of ordinary skill in the art, using the disclosures provided herein, will understand that the steps of the methods 800, 900, and/or 1000 can be modified, adapted, rearranged, omitted, interchanged, or expanded in various ways without deviating from the scope of the present disclosure. Referring generally to FIGS. 8, 9, and 10, the methods 800, 900, and 1000 may be interrelated and/or may have one or more steps from one of the methods 800, 900, and 1000 combined with one or more other method(s) 800, 900, or 1000. Thus, those of ordinary skill in the art will recognize that the various steps of the exemplary methods described herein may be combined in various ways to arrive at additional embodiments within the scope of the present disclosure. Those of ordinary skill in the art, using the disclosures provided herein, will understand that (except as otherwise indicated) methods 800, 900, and 1000 are not mutually exclusive. Moreover, the steps of the methods 800, 900, and 1000 can be modified, adapted, rearranged, omitted, interchanged, or expanded in various ways without deviating from the scope of the present disclosure.

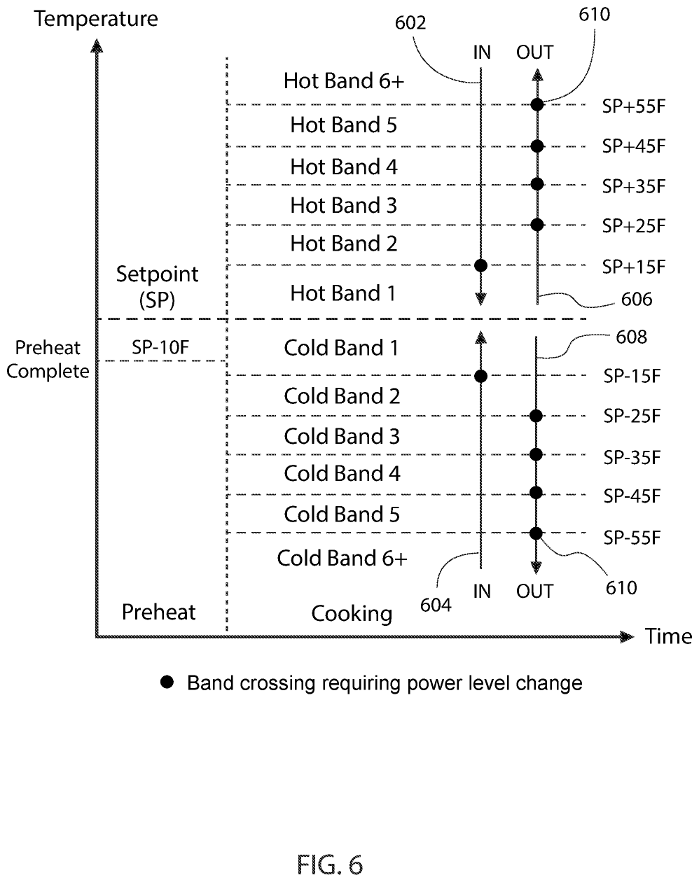

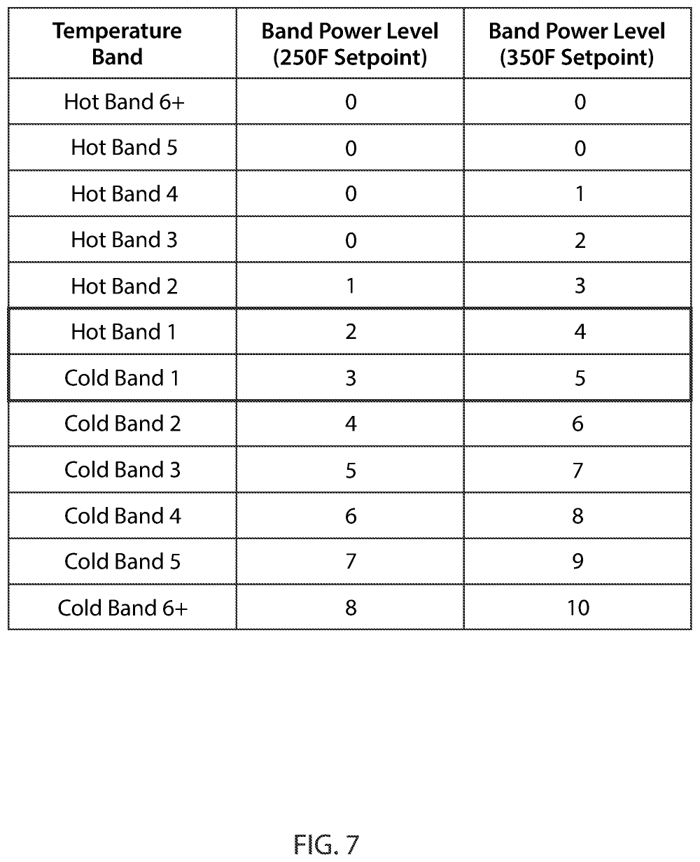

FIG. 6 graphically illustrates an exemplary plurality of temperature bands, a series of temperature changes across the temperature bands, and power level changes which correspond to at least some of the temperature changes, e.g., at certain band crossings, in an exemplary precision cooking operation according to one or more embodiments of the present disclosure. FIG. 7 provides an exemplary lookup table for power levels based on temperature bands and setpoint temperatures, which may be user-defined setpoint temperatures, as described above. Exemplary values, e.g., of temperature and/or power, are provided in FIGS. 6 and 7 solely for the purposes of discussion and are not intended to limit the present invention in any respect.

As indicated in FIG. 6, in some embodiments, an exemplary cooking operation, e.g., in precision cooking mode, may include a preheat stage or preheat phase prior to a cooking stage or phase. The preheat stage may include operating the heating element at a fixed and predetermined power level until a target temperature at the utensil is reached. The preheat stage may also include measuring, e.g., with the temperature sensor, the temperature at the utensil heated by the heating element until the target temperature is reached, where the target temperature may be, e.g., ten degrees Fahrenheit (10° F.) below the setpoint temperature (SP−10° F.), as in the example illustrated in FIG. 6. The exemplary cooking operation may also include exiting the preheat stage and beginning the cooking stage when the measured temperature at the utensil reaches the target temperature.

Still referring to FIG. 6, the exemplary cooking operation or cooking phase (e.g., if a preheat phase is included) may be controlled by a closed loop control algorithm, such as a temperature band based control algorithm. As illustrated in FIG. 6, such control algorithm may include temperature bands of varying widths, such as each band may have a different width from the width of every other band, or some bands may have the same width while one or more other bands have different widths, or all bands may have the same width. In the particular example embodiment illustrated in FIG. 6, the temperature bands are symmetrical about the setpoint (SP) temperature, e.g., the cold bands which represent temperatures below the SP temperature each have a same width as a corresponding hot band which represents temperatures above the SP temperature.

Continuing with the example embodiment illustrated in FIG. 6, each band adjacent to the SP temperature, e.g., Cold Band 1 and Hot Band 1, covers a range of up to fifteen degrees Fahrenheit (15° F.) below or above the SP temperature. Thus, in the example embodiment illustrated in FIG. 6, Hot Band 1 is bounded by the SP temperature at a lower limit and the upper boundary of Hot Band 1 is fifteen degrees Fahrenheit (15° F.) above the SP temperature (SP+15° F.), while Cold Band 1 is bounded by the SP temperature at an upper limit and the lower boundary of Cold Band 1 is fifteen degrees Fahrenheit (15° F.) below the SP temperature (SP−15° F.). Moving further away from the SP temperature, each subsequent band is bounded at an iteration of ten degrees Fahrenheit (10° F.) from the SP. Thus, for example, Cold Band 2 and Hot Band 2 are bounded by Cold Band 1 and Hot Band 1, respectively, and at SP+25° F., Cold Band 3 and Hot Band 3 are bounded by Cold Band 2 and Hot Band 2, respectively, and at SP+35° F., and so on. Bands up to six in each direction from the SP temperature, e.g., Hot Band 6 and Cold Band 6, are illustrated by way of example in FIG. 6. Additional bands, e.g., Hot Band 6+ and/or Cold Band 6+, may also be defined, such as at continuing intervals of ten degrees Fahrenheit (10° F.). Additionally, it should be understood that the foregoing ranges are only examples and the ranges could be more or less than those examples.

FIG. 6 illustrates an exemplary cooking operation which includes a preheat phase that occurs prior to the cooking phase. As indicated along the horizontal time axis illustrated in FIG. 6, the exemplary cooking operation includes the preheat phase during which the heating element may, for example, be operated at a constant power level, such as at a predetermined power level based on the SP temperature, followed by the cooking phase. In some exemplary embodiments, the closed loop control algorithm may control the power level of the heating element during the cooking phase based on which band the current measured temperature falls in. More particularly, the closed loop control algorithm may set the power level of the heating element to a power level corresponding to the current temperature band (such as the exemplary predetermined power levels based on the SP temperature and temperature band illustrated in FIG. 7 and described in further detail below) and may adjust the power level in response to the measured temperature crossing into another band. In at least some embodiments, the power level may be adjusted in response to only some of the band crossings, e.g., such as at band crossings indicated with dots 610 in FIG. 6.

As illustrated in FIG. 6, a series of exemplary temperature changes which may occur during one or more cooking operations are represented by arrows 602, 604, 606, and 608. Arrows 602 and 604 represent temperature changes in which the measured temperature is moving IN, e.g., is approaching the SP temperature. In particular, arrow 602 represents temperature changes as the measured temperature is above, e.g., greater than, the SP temperature, and is decreasing towards the SP temperature, whereas arrow 604 represents temperature changes as the measured temperature is below, e.g., less than, the SP temperature, and is increasing towards the SP temperature. Arrows 606 and 608 represent temperature changes in which the measured temperature is moving OUT, e.g., away from the SP temperature. In particular, arrow 606 represents temperature changes as the measured temperature is above, e.g., greater than, the SP temperature, and is increasing away from the SP temperature, whereas arrow 608 represents temperature changes as the measured temperature is below, e.g., less than, the SP temperature, and is decreasing away from the SP temperature.

As noted above, the preheat phase ends and the cooking phase begins when the measured temperature is within a predetermined threshold, e.g., ten degrees Fahrenheit (10° F.), of the SP temperature, e.g., when the measured temperature is at SP−10° F. In general, the preheat phase (if any) may end when the measured temperature is within the first band below the SP temperature (e.g., Cold Band 1), such that the cooking phase begins with the heating element operating at a power level corresponding to Cold Band 1. In some example cases, the measured temperature may increase from Cold Band 1 until the measured temperature crosses the SP temperature and enters into Hot Band 1. When moving across the SP temperature, e.g., from one of Hot Band 1 and Cold Band 1 to the other, the power level of the heating element is changed, e.g., the power level corresponding to the current temperature band is applied.

After crossing the SP temperature, if the measured temperature continues to move OUT, e.g., along either arrow 606 or 608, the power level of the heating element is not adjusted at the next band crossing, e.g., as indicated in FIG. 6, a power level change is not initiated when crossing from Cold Band 1 to Cold Band 2 (along arrow 608) or when crossing from Hot Band 1 to Hot Band 2 (along arrow 606). However, if the measured temperature still continues to move OUT, the power level of the heating element may be adjusted at one or more subsequent band crossings, such as at each subsequent band crossing. For example, the power level may be changed when the measured temperature moves from Cold Band 2 to Cold Band 3 along arrow 608 (as indicated by the dot 610 at the boundary between Cold Bands 2 and 3), from Cold Band 3 to Cold Band 4, and so on. Similarly, the power level may be changed when the measured temperature moves along arrow 606 from Hot Band 2 to Hot Band 3 (as indicated by the dot 610 at the boundary between Hot Bands 2 and 3), from Hot Band 3 to Hot Band 4, and so on. Thus, in general, the power level may adjust when moving away from the SP temperature (without crossing the SP temperature) only when the first temperature band is at least Band 2 (hot or cold).

When a first measured temperature is within a temperature band separated from the SP temperature by two or more intervening temperature bands, e.g., when the first measured temperature is within Cold Band 3 or greater (“greater” in this context meaning a higher-numbered temperature band, which refers to a colder temperature in the context of cold bands, e.g., a larger difference between the SP temperature and the current measured temperature), or is within Hot Band 3 or greater, and a second (subsequent) measured temperature is within an adjacent band that is closer to the SP temperature, e.g., the temperature change is along arrow 602 or 604, the power level of the heating element may not be changed. That is, the power level may be held constant as the measured temperature approaches the SP temperature (e.g., moves IN), until the measured temperature crosses into a temperature band bounded by the SP temperature, e.g., crosses into Hot Band 1 or Cold Band 1 along arrow 602 or arrow 604.

As shown in FIG. 7, power levels for the various temperature bands may be stored in a lookup table. FIG. 7 provides example power levels at each temperature band based on illustrative setpoint values. As with the widths of the bands described above with respect to FIG. 6, the power levels of FIG. 7 are also only examples and other power levels may be used, and additional sets of power levels for each temperature band may be provided for different SP temperatures. Also, when the SP temperature falls between two temperatures for which power levels are provided, the power level at each temperature band may be interpolated, such as based on a weighted average of the predetermined power levels with weights corresponding to the distance between the given SP temperature and each adjoining SP temperature for which predetermined power levels are provided.

An exemplary method 800 of operating a cooktop appliance is illustrated in FIG. 8. Method 800 begins at a start point 802, which may, in various embodiments, be the beginning of a cooking operation or the beginning of a cooking phase of a cooking operation following a preheat phase. During the cooking operation or cooking phase, exemplary method 800 includes a decision function, e.g., of determining whether a band change has occurred, e.g., whether a current measured temperature has crossed from one temperature band into another, as indicated at 804 in FIG. 8. When there is no band change, method 800 proceeds to decision function 806 to determine whether there is a pending power level (PL) change. When there is no pending PL change, e.g., when the determination at decision function 806 is “No,” method 800 may reiterate by continuing back to decision function 804, as illustrated in FIG. 8.

When there is a pending PL change, e.g., when the determination at decision function 806 is “Yes,” method 800 may proceed to decision function 808 wherein a time since the last power level (PL) change is compared to a time threshold of X minutes (mins). The time threshold X may, for example, be between about one minute (1 min) and about five minutes (5 mins), such as between about one and a half minutes (1.5 mins) and about three minutes (3 mins), such as about two minutes (2 mins). For example, when there is a pending PL change, the pending PL change may be held for at least the time threshold (e.g., for at least X mins, or until the time since last PL change is greater than X mins). Thus, for example, when the time since the last PL change is less than or equal to X mins (is not greater than X mins), method 800 may loop back to decision function 804. Also by way of example, when there is a pending PL change and the time since the last PL change is greater than X mins (e.g., when the result of decision function 806 is Yes and the result of decision function 808 is also Yes), the pending PL change may then be applied, e.g., the method 800 may proceed to process function 810 and apply the power level (PL) for the current band.

When there is a band change, e.g., when a current measured temperature is within a different temperature band than a previous measured temperature, such as a most recent previous measured temperature, such that the result of decision function 804 is Yes, method 800 may continue to decision function 812 of determining whether the time since the last PL change is greater than X mins, where the value of the time threshold X mins may be within the exemplary ranges described above with respect to decision function 808. When the time since the last PL change is not greater than X mins at 812 (e.g., when the time limit since the last power level change has not elapsed), method 800 may then proceed to decision function 814 and determine a rate of temperature change, such as determining whether the temperature has changed by more than a temperature change threshold (Y levels) within a time limit in seconds (Z secs). The temperature change threshold Y levels may be, for example, two bands. For example, a temperature change greater than Y levels, where Y equals two, may be a temperature change by three bands, such as from band 2 to band 5 (hot or cold), in which case the first band is band 2, the second band is band 5, and there are two intervening bands between the first band and the second band, the two intervening bands being bands 3 and 4. Thus, in some embodiments, when the second temperature band is separated from the first temperature band by Y (e.g., two) or more intervening temperature bands and the measured temperature went from the first temperature band to the second temperature band within the time limit Z secs at 814, method 800 may proceed to decision function 818, which will be described further below. When the result of decision function 814 is No, e.g., when the temperature band change is less than or equal to Y levels and/or the band change occurred over more than Z secs, method 800 may continue to process function 816, and set the power level (PL) request (e.g., the request to operate the heating element at the power level corresponding to the current temperature band) as pending. Such pending PL change request may later be applied, e.g., based on decision functions 806 and 808 as described above.

When the result of decision function 812 is Yes, or when the result of decision function 812 is No and the result of decision function 814 is Yes, method 800 may continue to a decision function 818 of determining whether the measured temperature is moving away from the setpoint (SP), for example, whether the temperature change is along one of the OUT arrows 606 and 608 illustrated in FIG. 6 and described above.

When the result of decision function 818 is No, e.g., when the measured temperature is moving IN (e.g., along one of arrows 602 and 604 in FIG. 6) towards the SP temperature, method 800 may proceed to decision function 820. At decision function 820, method 800 may determine whether the new band is bounded by the SP temperature, such as whether the new band is Cold Band 1 or Hot Band 1. The new band may be, e.g., the temperature band into which the measured temperature has moved, which may be a second temperature of a first and second temperature, or may be any other subsequent temperature in a series of temperatures. When the temperature is moving IN and the new band is not Cold Band 1 or Hot Band 1, e.g., when the result of decision function 820 is No, method 800 may return to decision function 804. When the temperature is moving IN and the new band is Cold Band 1 or Hot Band 1, e.g., when the result of decision function 820 is Yes, method 800 may then proceed to process function 810 and apply the PL for the current band (new band).

When the measured temperature is moving away from the setpoint (e.g., along one of the OUT arrows 606 and 608 in FIG. 6) at decision function 818, method 800 may then include a process function 822 of waiting a steadying time (e.g., which may be measured in seconds, such as N secs as indicated at 822 in FIG. 8) if the measured temperature is decreasing. The steadying time N secs may be any suitable amount of time for the measured temperature to reach a steady state, such that waiting the steadying time may provide a more efficient control with fewer operations of the control, e.g., power switch, such as the control algorithm may not chase the measured temperature through several bands in the event of a large shift in temperature (such as may occur when a food item is added to the utensil). Thus, when the temperature is dropping (e.g., if drop in temp, as noted at 822 in FIG. 8), method 800 may include waiting until the steadying time N secs has elapsed with the measured temperature in the same band before proceeding. The steadying time N secs may be any suitable amount of time, such as between about two seconds (2 secs) and about fifteen seconds (15 secs), such as between about three seconds (3 secs) and about ten seconds (10 secs), such as about five seconds (5 secs).

When the result of decision function 818 is Yes, and, if the measured temperature dropped or is dropping, after the steadying time N secs in the same band, method 800 may continue to decision function 824. At decision function 824, method 800 may include determining whether the new band is separated from the SP temperature by at least two intervening temperature bands. For example, decision function 824 may include determining whether the new band is Cold Band 3 or lower (thus separated from the SP temperature by at least intervening bands Cold Band 1 and Cold Band 2), where “lower” in this context means the measured temperature is lower, which in the context of cold bands means the measured temperature is farther from the SP temperature. Decision function 824 may also include determining whether the new band is Hot Band 3 or higher (thus separated from the SP temperature by at least intervening bands Hot Band 1 and Hot Band 2). When the result of decision function 824 is Yes, method 800 may move to process function 810 and apply the power level (PL) for the current band. When the result of decision function 824 is No, method 800 may be recursive (throughout the duration of the cooking operation or cooking phase) and may thus return to decision function 804.

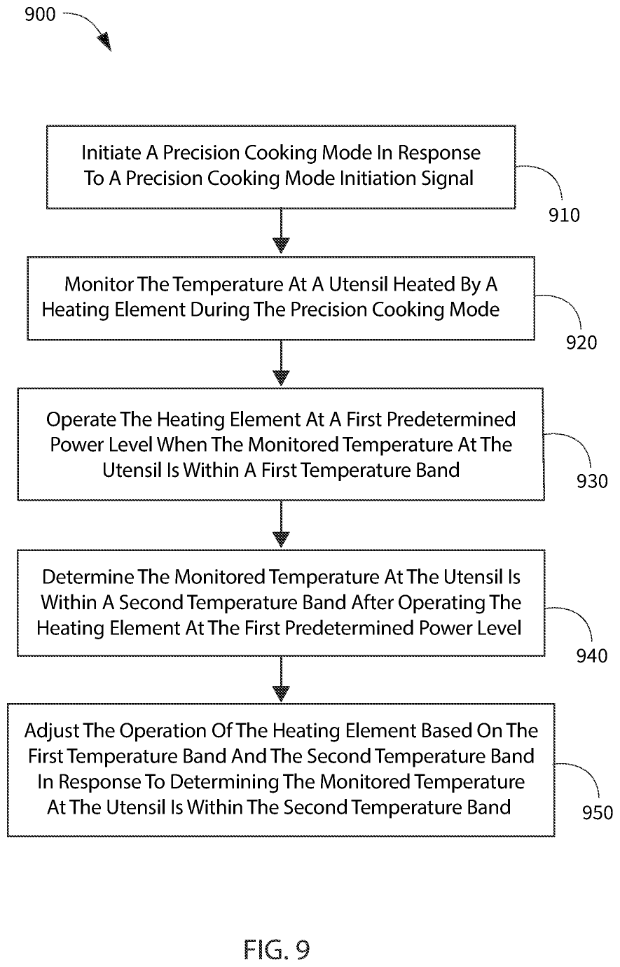

Turning now to FIG. 9, an example method 900 of operating a cooktop appliance, such as the example appliance 100 described above, is illustrated. Thus, the cooktop appliance which is operated according to the exemplary method 900 may include a user interface, a heating element positioned at a cooking surface of the cooktop appliance, and a temperature sensor configured to measure a temperature at a utensil heated by the heating element. The method 900 may include receiving a precision cooking mode initiation signal, e.g., from a user interface, such as user interface 62, of the cooktop appliance and initiating the precision cooking mode in response to the precision cooking mode initiation signal, as indicated at (910) in FIG. 9.

The precision cooking mode initiation signal may be received from the user interface, e.g., user interface panel 154 and/or knobs 156. The precision cooking mode initiation signal may represent or correspond to a user request for the precision cooking mode based on a user pressing a precision cooking mode key or button 157 or otherwise entering the request via the user interface 62. The precision cooking mode may utilize a closed loop control system in at least one stage of the precision cooking mode, where the closed loop control system may operate or adjust the cooktop appliance, e.g., power levels of one or more heating elements of the cooking appliance, based on input from a temperature sensor.

The precision cooking mode initiation signal (and, in at least some embodiments, a setpoint temperature) may be received from one or more of a user interface on the cooktop appliance and/or a remote user interface device. In exemplary embodiments where such inputs are also or instead received via the remote user interface device, the remote user interface device may be any suitable device such as a laptop computer, smartphone, tablet, personal computer, wearable device, smart speaker, smart home system, and/or various other suitable devices. The remote user interface device is “remote” at least in that it is spaced apart from and not physically connected to the cooktop appliance, e.g., the remote user interface device is a separate, stand-alone device from the cooktop appliance which communicates with the cooktop appliance wirelessly, e.g., through various possible communication connections and interfaces such as WI-FI®. The cooktop appliance and the remote user interface device may be matched in wireless communication, e.g., connected to the same wireless network. The cooktop appliance may communicate with the remote user interface device via short-range radio such as BLUETOOTH® or any other suitable wireless network having a layer protocol architecture. Any suitable device separate from the cooktop appliance that is configured to provide and/or receive communications, information, data, or commands from a user may serve as the remote user interface device, such as a smartphone, smart watch, personal computer, smart home system, or other similar device. For example, the remote user interface device may be a smartphone operable to store and run applications, also known as “apps,” and some or all of the method steps disclosed herein may be performed by a smartphone app.

The precision cooking mode may include activating the heating element positioned at the cooking surface. For example, the precision cooking mode may include activating the heating element at a power level determined by a closed loop control algorithm, such as a closed loop control algorithm based on temperature bands, e.g., as described above.

As illustrated in FIG. 9, exemplary embodiments of the method 900 may also include monitoring the temperature at the utensil heated by the heating element during the precision cooking mode, e.g., as indicated at (920), and operating the heating element at a first predetermined power level when the monitored temperature at the utensil is within a first temperature band, e.g., as indicated at (930). It is to be understood that the “first” temperature band is not necessarily the very first temperature band, e.g., is not necessarily the temperature band in which the measured temperature falls immediately after preheat or otherwise at the beginning of the cooking phase or cooking operation, instead, the measured temperature may be first temperature band at any point in the cooking operation, e.g., prior to a second temperature band. For example, method 900 may also include (490) determining the monitored temperature at the utensil is within a second temperature band after operating the heating element at the first predetermined power level. Thus, the second temperature band occurs after the first temperature band, may be immediately after the first temperature band, and may be a current temperature band when the heating element is adjusted, e.g., when the power level of the heating element is adjusted. In various embodiments, the measured temperature may fall within one or more other additional temperature bands before and/or after the first and second temperature bands.

As indicated at (950), method 900 may also include adjusting the operation of the heating element based on the first temperature band and the second temperature band in response to determining the monitored temperature at the utensil is within the second temperature band. Thus, e.g., in contrast to simply setting power based on the current temperature band, exemplary methods according to the present disclosure may include a power level that is dependent on both the current temperature band and the immediate prior temperature band, e.g., the power level may be adjusted based on a particular band crossing such that the power level is dependent on which temperature band the measured temperature is currently in (e.g., second temperature band) and on which temperature band the measured temperature was most recently in (e.g., first temperature band). For example, if the second temperature band is Hot Band 4 (FIG. 6) and the first temperature band was Hot Band 3, then the operation of the heating element may be adjusted to the power level corresponding to Hot Band 4, whereas in another example, if the second temperature band is Hot Band 4 and the first temperature band was Hot Band 5, then the operation of the heating element may not be adjusted to the power level corresponding to Hot Band 4.

Adjusting operation of the heating element may include adjusting the power level of the heating element. As mentioned above, the heating element, e.g., heating element 16, may be any suitable type of heating element. For example, in some embodiments, the heating element may be or include a gas burner. In such embodiments, the power level of the heating element, e.g., which may be determined by the closed loop control algorithm, such as based on the temperature bands, may correspond to a position of a fuel supply valve coupled to the gas burner. As another example, in additional embodiments, the heating element may also or instead be or include an electric heating element. In such embodiments, the power level of the heating element may correspond to a level of electric power supplied to the heating element.

In some embodiments, the second temperature band may be farther from a setpoint (SP) temperature than the first temperature band, and the first temperature band may be separated from the setpoint temperature by at least one intervening temperature band. For example, the first temperature band may be Cold Band 2, and thus separated from the SP temperature by one intervening temperature band, Cold Band 1. Continuing the example, the second temperature band farther from the SP temperature may be Cold Band 3. Thus, as may be seen with reference to FIG. 6, when the measured temperature crosses from a temperature band separated from the setpoint temperature by at least one intervening temperature band to another temperature band that is farther from the SP temperature, e.g., from either band 2 (hot or cold) to a higher-numbered band along arrow 606 or 608, the operation, e.g., power level, of the heating element may be adjusted based on such crossing.

In some embodiments, the second temperature band may be bounded by the SP temperature and the first temperature band may be separated from the SP temperature by the second temperature band. Thus, when the second temperature band is band 1 (hot or cold), and the measured temperature enters the temperature band bounded by the SP temperature from a higher-numbered band, e.g., the measured temperature is approaching (moving IN towards) the SP temperature, the operation, e.g., power level, of the heating element may be adjusted based on such crossing.

In some embodiments, method 900 may also include determining a time limit since a last power level change has elapsed prior to adjusting the operation of the heating element. In such embodiments, adjusting the operation of the heating element may be further based on the elapsed time limit since the last power level change. For example, as discussed above with respect to decision functions 808 and 812 in FIG. 8, method 900 may include holding a current power level and setting a request to adjust the power level as pending when the time limit X mins has not elapsed since the last (most recent) power level change.

In some embodiments, the time limit X mins may be overridden if the temperature change is large enough and/or fast enough. For example, method 900 may include determining a time limit since a last power level change has not elapsed prior to adjusting the operation of the heating element, determining the second temperature band is separated from the first temperature band by two or more intervening temperature bands, and determining the temperature at the utensil went from the first temperature band to the second temperature band within a time limit.

Thus, the temperature change may be large enough to override the time limit, e.g., when the temperature changes by greater than Y levels (see, e.g., FIG. 8, at 814). For example, where Y equals two, the second temperature band may be separated from the first temperature band by two or more intervening temperature bands. For instance the temperature may change by three levels, such as from band 2 to band 5 (hot or cold), where the two intervening temperature bands would be bands 3 and 4. In such embodiments, adjusting the operation of the heating element may be further based on the size and speed of the temperature change, e.g., may be further based on determining the second temperature band is separated from the first temperature band by two or more intervening temperature bands and determining the temperature at the utensil went from the first temperature band to the second temperature band within the time limit.

In some embodiments, method 900 may include determining a time limit since a last power level change has not elapsed prior to adjusting the operation of the heating element, and determining the second temperature band is separated from the first temperature band by less than two intervening temperature bands. In such embodiments, method 900 may further include setting a pending power level change request in response to determining the time limit has not elapsed and determining the second temperature band is separated from the first temperature band by less than two intervening temperature bands, e.g., in a similar manner as discussed above with respect to function 816 in FIG. 8. In such embodiments, adjusting the operation of the heating element may include waiting for the time limit to elapse and applying the pending power level change request after the time limit has elapsed, e.g., in a similar manner as discussed above with respect to functions 806 and 808 in FIG. 8.

In some embodiments, the monitored temperature at the utensil within the second temperature band may be less than the monitored temperature at the utensil within the first temperature band. Such embodiments may further include waiting until the monitored temperature at the utensil is within the second temperature band for at least a steadying time, e.g., in a similar manner as described above with respect to function 822 in FIG. 8, before adjusting the operation of the heating element based on the first temperature band and the second temperature band in response to determining the monitored temperature at the utensil is within the second temperature band. Such embodiments may also include determining the second temperature band is separated from a setpoint temperature by at least two intervening temperature bands prior to adjusting the operation of the heating element. For example, the second temperature band may be separated from a setpoint temperature by at least two intervening temperature bands when the second temperature band is Cold Band 3 (separated from SP temperature by two intervening bands, Cold Band 1 and Cold Band 2) or another cold band at lower temperatures than Cold Band 3, or the second temperature band may be separated from a setpoint temperature by at least two intervening temperature bands when the second temperature band is Hot Band 3 (separated from SP temperature by two intervening bands, Hot Band 1 and Hot Band 2) or another hot band at higher temperatures than Hot Band 3. For example, determining the second temperature band is separated from a setpoint temperature by at least two intervening temperature bands prior to adjusting the operation of the heating element may be similar to function 824 in FIG. 8 described above.

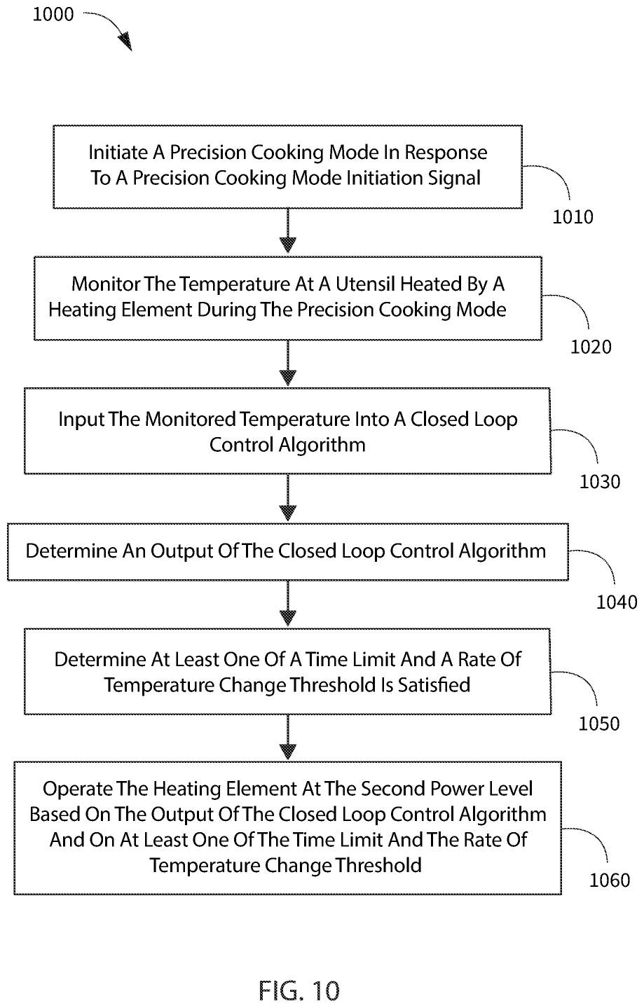

Another exemplary method 1000 of operating a cooktop appliance is illustrated in FIG. 10. As shown at (1010) in FIG. 10, method 1000 may include receiving a precision cooking mode initiation signal and a setpoint temperature and initiating the precision cooking mode in response to the precision cooking mode initiation signal. The precision cooking mode may include activating the heating element positioned at the cooking surface at a first power level. The first power level may be based on the setpoint temperature.

Method 1000 may further include monitoring the temperature at the utensil heated by the heating element during the precision cooking mode (1020) and inputting the monitored temperature into a closed loop control algorithm (1030). Method 1000 may also include determining an output of the closed loop control algorithm (1040). In various embodiments, the closed loop control algorithm at (1030) and (1040) may be a proportional-integral (PI) control algorithm, a proportional-integral-derivative (PID) control algorithm, a temperature band based algorithm, or any other suitable closed loop control algorithm. The output of the closed loop control algorithm at (1040) may include a request to operate the heating element at a second power level, e.g., a power level different from the first power level, such as a higher or lower power level in response to a comparison of the measured temperature over time to the setpoint temperature, as is generally understood by those of ordinary skill in the art of closed loop controls.

Method 1000 may also include determining at least one of a time limit and a rate of temperature change threshold is satisfied (1050) after determining the output of the closed loop control algorithm and operating the heating element at the second power level based on the output of the closed loop control algorithm and on the at least one of the time limit and the rate of temperature change threshold (1060). Accordingly, method 1000 may not implement every request to change the power level of the heating element that is output from the closed loop control algorithm throughout the cooking process, such as method 1000 may only adjust the power level when at least one of the time limit and the rate of temperature change threshold is satisfied. The time limit may be, for example, a time limit since the last power level change, such as X mins, as described above with respect to FIG. 8. The temperature change threshold may be defined in terms of an amount of temperature change and/or a rate of temperature change, such as a temperature change by at least a certain amount within a certain time, e.g., Y levels in Z secs, as described above in reference to FIG. 8.

In some embodiments, determining at least one of the time limit and the rate of temperature change threshold is satisfied after determining the output of the closed loop control algorithm may include determining the time limit is satisfied. In such embodiments, operating the heating element at the second power level may be based on the output of the closed loop control algorithm and on the time limit.

In some embodiments, determining at least one of the time limit and the rate of temperature change threshold is satisfied after determining the output of the closed loop control algorithm may include determining the time limit is not satisfied and determining the temperature change threshold is satisfied. In such embodiments, operating the heating element at the second power level may be based on the output of the closed loop control algorithm and on the temperature change threshold.

In some embodiments, the output comprising the request to operate the heating element at the second power level may be based on the monitored temperature decreasing. Such embodiments may further include waiting until the monitored temperature at the utensil reaches a steady state before operating the heating element at the second power level. For example, waiting until the monitored temperature at the utensil reaches a steady state may include waiting for a steadying time to elapse.

In some embodiments, the closed loop control algorithm may be a temperature band based algorithm, e.g., the closed loop control algorithm may include determining the monitored temperature at the utensil is currently in a current temperature band of a plurality of predefined temperature bands, comparing the current temperature band to a previous temperature band the monitored temperature at the utensil was in while operating the heating element at the first power level, and generating the output of the closed loop algorithm based on the current temperature band and the previous temperature band. In such embodiments, the rate of temperature change threshold may be defined by a number of the plurality of predefined temperature bands crossed within a time period.

Aspects of the present disclosure may provide several advantages. For example, and without limitation, the present disclosure may provide a more responsive control with fewer overshoots, smaller overshoots, and faster recovery time. As another example, the present disclosure may advantageously provide less frequent power adjustments, such that electromechanical components such as switches experience less wear. As a further example, control algorithms according to the present disclosure may advantageously provide a more predictable effect when a designer sets the power levels at each temperature band, e.g., as compared to control algorithms in which it is harder to predict the effect of changing gain values. Those of ordinary skill in the art will recognize that the foregoing advantages are provided by way of example only, the present disclosure may provide additional advantages and benefits as well as or instead of the foregoing examples, and none of the examples are limiting, e.g., embodiments of the present disclosure do not require any or all such advantages be provided in every embodiment.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of operating a cooktop appliance, the cooktop appliance comprising a user interface, a heating element positioned at a cooking surface of the cooktop appliance, and a controller in communication with a temperature sensor configured to measure a temperature at a utensil heated by the heating element, the method comprising:
receiving a precision cooking mode initiation signal;
initiating the precision cooking mode in response to the precision cooking mode initiation signal, wherein the precision cooking mode comprises activating the heating element positioned at the cooking surface;
monitoring the temperature at the utensil heated by the heating element during the precision cooking mode;
operating the heating element at a first predetermined power level when the monitored temperature at the utensil is within a first temperature band;
determining, after operating the heating element at the first predetermined power level, the monitored temperature at the utensil is within a second temperature band; and
adjusting the operation of the heating element based on the first temperature band and the second temperature band in response to determining the monitored temperature at the utensil is within the second temperature band.

2. The method of claim 1, wherein the second temperature band is farther from a setpoint temperature than the first temperature band, and wherein the first temperature band is separated from the setpoint temperature by at least one intervening temperature band.

3. The method of claim 1, wherein the second temperature band is bounded by a setpoint temperature and the first temperature band is separated from the setpoint temperature by the second temperature band.

4. The method of claim 1, further comprising determining a time limit since a last power level change has elapsed prior to adjusting the operation of the heating element, wherein adjusting the operation of the heating element is further based on the elapsed time limit since the last power level change.

5. The method of claim 1, further comprising determining a time limit since a last power level change has not elapsed prior to adjusting the operation of the heating element, determining the second temperature band is separated from the first temperature band by two or more intervening temperature bands, and determining the temperature at the utensil went from the first temperature band to the second temperature band within a time limit, wherein adjusting the operation of the heating element is further based on determining the second temperature band is separated from the first temperature band by two or more intervening temperature bands and determining the temperature at the utensil went from the first temperature band to the second temperature band within the time limit.

6. The method of claim 1, further comprising determining a time limit since a last power level change has not elapsed prior to adjusting the operation of the heating element, and determining the second temperature band is separated from the first temperature band by less than two intervening temperature bands, further comprising setting a pending power level change request in response to determining the time limit has not elapsed and determining the second temperature band is separated from the first temperature band by less than two intervening temperature bands, wherein adjusting the operation of the heating element comprises waiting for the time limit to elapse and applying the pending power level change request after the time limit has elapsed.

7. The method of claim 1, wherein the monitored temperature at the utensil within the second temperature band is less than the monitored temperature at the utensil within the first temperature band, further comprising waiting until the monitored temperature at the utensil is within the second temperature band for at least a steadying time before adjusting the operation of the heating element based on the first temperature band and the second temperature band in response to determining the monitored temperature at the utensil is within the second temperature band.

8. The method of claim 7, further comprising determining the second temperature band is separated from a setpoint temperature by at least two intervening temperature bands prior to adjusting the operation of the heating element.

9. A method of operating a cooktop appliance, the cooktop appliance comprising a user interface, a heating element positioned at a cooking surface of the cooktop appliance, and a controller in communication with a temperature sensor configured to measure a temperature at a utensil heated by the heating element, the method comprising:
receiving a precision cooking mode initiation signal and a setpoint temperature;
initiating the precision cooking mode in response to the precision cooking mode initiation signal, wherein the precision cooking mode comprises activating the heating element positioned at the cooking surface at a first power level, the first power level based on the setpoint temperature;
monitoring the temperature at the utensil heated by the heating element during the precision cooking mode;
inputting the monitored temperature into a closed loop control algorithm;
determining an output of the closed loop control algorithm, the output comprising a request to operate the heating element at a second power level;
determining at least one of a time limit and a rate of temperature change threshold is satisfied after determining the output of the closed loop control algorithm; and
operating the heating element at the second power level based on the output of the closed loop control algorithm and on the at least one of the time limit and the rate of temperature change threshold.

10. The method of claim 9, wherein determining at least one of the time limit and the rate of temperature change threshold is satisfied after determining the output of the closed loop control algorithm comprises determining the time limit is satisfied, wherein operating the heating element at the second power level is based on the output of the closed loop control algorithm and on the time limit.

11. The method of claim 9, wherein determining at least one of the time limit and the rate of temperature change threshold is satisfied after determining the output of the closed loop control algorithm comprises determining the time limit is not satisfied and determining the temperature change threshold is satisfied, wherein operating the heating element at the second power level is based on the output of the closed loop control algorithm and on the temperature change threshold.

12. The method of claim 9, wherein the output comprising the request to operate the heating element at the second power level is based on the monitored temperature decreasing, further comprising waiting until the monitored temperature at the utensil reaches a steady state before operating the heating element at the second power level.

13. The method of claim 9, wherein the closed loop control algorithm comprises determining a current temperature band of a plurality of predefined temperature bands the monitored temperature at the utensil is currently in, comparing the current temperature band to a previous temperature band the monitored temperature at the utensil was in while operating the heating element at the first power level, and generating the output of the closed loop algorithm based on the current temperature band and the previous temperature band.

14. The method of claim 13, wherein the rate of temperature change threshold is defined by a number of the plurality of predefined temperature bands crossed within a time period.

15. A cooktop appliance, comprising:
a user interface;
a heating element positioned at a cooking surface of the cooktop appliance; and
a controller in communication with a temperature sensor configured to measure a temperature at a utensil heated by the heating element, the controller configured for:
receiving a precision cooking mode initiation signal;
initiating the precision cooking mode in response to the precision cooking mode initiation signal, wherein the precision cooking mode comprises activating the heating element positioned at the cooking surface;
monitoring the temperature at the utensil heated by the heating element during the precision cooking mode;
operating the heating element at a first predetermined power level when the monitored temperature at the utensil is within a first temperature band;
determining, after operating the heating element at the first predetermined power level, the monitored temperature at the utensil is within a second temperature band; and
adjusting the operation of the heating element based on the first temperature band and the second temperature band in response to determining the monitored temperature at the utensil is within the second temperature band.

16. The cooking appliance of claim 15, wherein the controller is configured for adjusting the operation of the heating element based on the first temperature band and the second temperature band when the second temperature band is farther from a setpoint temperature than the first temperature band and the first temperature band is separated from the setpoint temperature by at least one intervening temperature band.

17. The cooking appliance of claim 15, wherein the controller is configured for adjusting the operation of the heating element based on the first temperature band and the second temperature band when the second temperature band is bounded by a setpoint temperature and the first temperature band is separated from the setpoint temperature by the second temperature band.

18. The cooking appliance of claim 15, wherein the controller is further configured for determining a time limit since a last power level change has elapsed prior to adjusting the operation of the heating element, wherein adjusting the operation of the heating element is further based on the elapsed time limit since a last power level change.

19. The cooking appliance of claim 15, wherein the controller is further configured for determining a time limit since a last power level change has not elapsed prior to adjusting the operation of the heating element, determining the second temperature band is separated from the first temperature band by two or more intervening temperature bands and determining the temperature at the utensil went from the first temperature band to the second temperature band within a time limit, wherein adjusting the operation of the heating element is further based on determining the second temperature band is separated from the first temperature band by two or more intervening temperature bands and determining the temperature at the utensil went from the first temperature band to the second temperature band within the time limit.

20. The cooking appliance of claim 15, wherein the controller is further configured for determining a time limit since a last power level change has not elapsed prior to adjusting the operation of the heating element, and determining the second temperature band is separated from the first temperature band by less than two intervening temperature bands, further comprising setting a pending power level change request in response to determining the time limit has not elapsed and determining the second temperature band is separated from the first temperature band by less than two intervening temperature bands, wherein adjusting the operation of the heating element comprises waiting for the time limit to elapse and applying the pending power level change request after the time limit has elapsed.
